(19) United States
(12) Patent Application Publication
(10) Pub. No.: US 2007/0014304 A1
(43) Pub. Date: Jan. 18, 2007

(54) Ethernet adapter

(75) Inventors: Ming-Fa Wu, Taoyuan Hsien (TW); Jen-Ho Chang, Taoyuan Hsien (TW); Han-Cheng Hsu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/397,643

(22) Filed: Apr. 5, 2006

(30) Foreign Application Priority Data
Jul. 15, 2005 (TW) 94124127

(51) Int. Cl. H04L 12/28

(52) U.S. Cl. 370/431

(57) ABSTRACT

An Ethernet adapter is electrically connected between a power line and an Internet apparatus. The Ethernet adapter includes a power converter and a data transmission processor. The power converter is electrically connected to the power line for converting power provided by the power line and outputting a converted result to the data transmission processor. The data transmission processor is stacked with the power converter and electrically connected to the power line for transmitting a data signal from the power line to the Internet apparatus.

This Non-provisional application claims priority under U.S.C.§ 119(a) on Patent Application No(s). 094124127 filed in Taiwan, Republic of China on Jul. 15, 2005, the entire contents of which are hereby incorporated by reference.

### BACKGROUND

The invention relates to an adapter and more particularly to an Ethernet adapter for voltage conversion and data transmission.

Referring to FIG. 1, it is an application diagram of a conventional Ethernet adapter. The Ethernet adapter 1 is electrically connected between a power line 2 and an Internet apparatus 3. The Ethernet adapter 1 includes a power converter 4 and a transmission chip 5, both electrically connected to the power line 2. The power converter 4 converts power of the power line 2 and transmits the converted result to the transmission chip 5 (i.e. AC power is converted to DC power, as shown in FIG. 1). The power converter 4 and the transmission chip 5 are electrically connected to the Internet apparatus 3 via a power plug 6 and a RJ-45 plug 7, respectively. As the results, the Internet apparatus 3 receives power via the power plug 6 and transmitted data via the RJ-45 plug 7.

In the Ethernet adapter 1, the power converter 4 and the transmission chip 5 are typically produced on a common printed circuit board (PCB). A large area is required accordingly (for sockets). Additionally, because only one copper ground plane is provided in the Ethernet adapter 1, this induces electromagnetic noise interference. Thus, these problems cause inconvenience to users during use or testing.

### SUMMARY

In view of the abovementioned problems, the invention discloses an Ethernet adapter. The Ethernet adapter is connected between a power line and an Internet apparatus for converting and transmitting a data signal. The Ethernet adapter includes a power converter stacked with a data transmission processor. The power converter converts the power of the power line into operating power, and then the operating power is used by the data transmission processor. The data transmission processor receives a data signal via the power line, converts the data signal to a converted data signal, and transmits the converted data signal to the Internet apparatus.

In the Ethernet adapter of the invention, since the power converter and the data transmission processor are stacked, a total area is reduced so that additional area is provided for accommodating more sockets. Moreover, the two-layer configuration also increases the area of the copper ground plane, thereby decreasing the interference of electromagnetic noise.

Further, more than one plug can be added to the power converter so as to provide power to different electronic devices at the same time. This conserves space for voltage transformer and sockets.

### BRIEF DESCRIPTION OF THE DRAWINGS

The foregoing and other advantages and features of the invention will become more apparent from the detailed description of embodiments of the invention given below with reference to the accompanying drawings in which:

FIG. 1 is an application diagram of a conventional Ethernet adapter; and

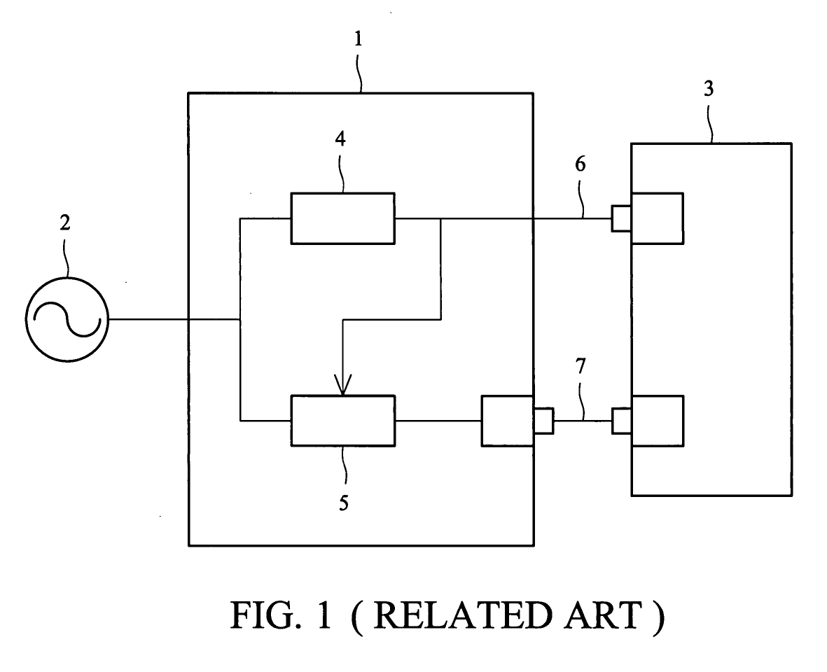

FIG. 2 is an application diagram of an Ethernet adapter in accordance with an embodiment of the invention, particularly illustrating the structure of the Ethernet adapter of the invention.

### DETAILED DESCRIPTION

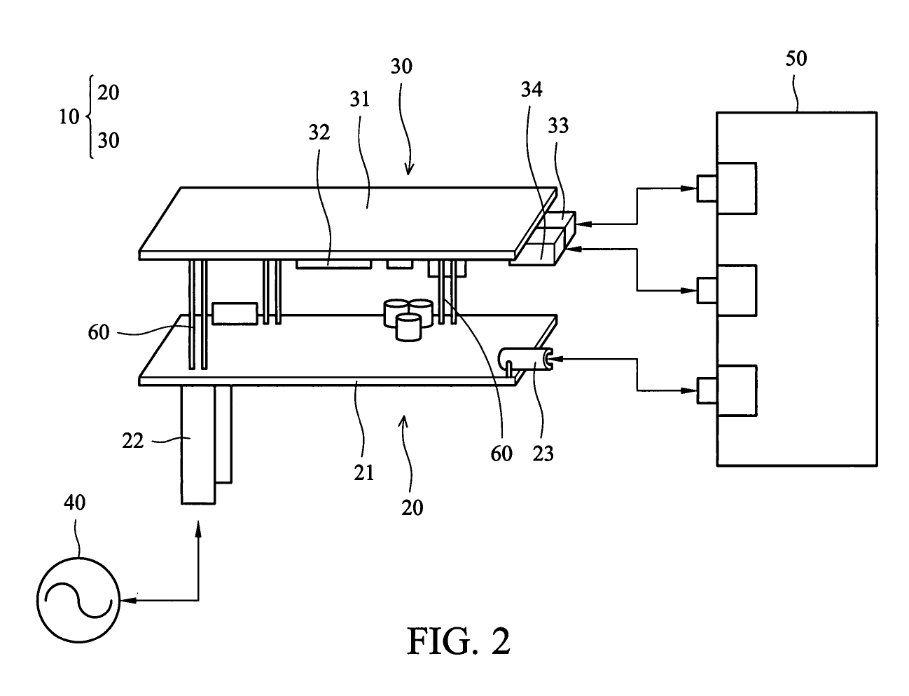

Referring to FIG. 2, it shows an Ethernet adapter 10 in accordance with an embodiment of the invention. The Ethernet adapter 10 includes a power converter 20 stacked with a data transmission processor 30, both of which are electrically connected between a power line 40 and an Internet apparatus 50.

The power converter 20 has a circuit board 21, on which a first plug 22, a second plug 23 and a conversion circuit (not shown) are disposed. The first plug 22 is electrically connected to the power line 40 for receiving AC power via the power line 40, and the AC power is converted to DC power by, the conversion circuit and outputted to the data transmission processor 30 via the second plug 23. It is noted that more than one second plug 23 can further be disposed in the power converter 20 so as to provide power to various apparatuses at the same time.

The data transmission processor 30 includes a circuit board 31, on which a transmission chip 32 and a driving circuit (not shown) are disposed. The driving circuit receives a converted data signal from the power line 40 and receives the power from the power converter 20 so as to drive the transmission chip 32 accordingly. The transmission chip 32 includes a power line coupler, an analog signal driver, an analog signal converter and an access controller.

The power line coupler of the transmission chip 32 captures and receives the data signal from the power line 40 and transmits the data signal to the analog signal driver. Alternatively, the power line coupler of the transmission chip 32 loads and inputs the data signal into the power line 40.

The analog signal driver amplifies the data signal to an amplified data signal for a better transmission quality.

The analog signal converter converts the amplified data signal to a converted data signal, such as analog to digital, or vice versa.

The access controller is used for access control and sharing of the converted data signal. The access controller is also responsible for modulation and coding of the converted data signal. Moreover, the access controller can be electrically connected to a RJ-45 plug 33 and a USB plug 34, respectively, for providing transmission with the Internet apparatus 50 via the RJ-45 plug 33, and directly acquiring the operating power to the data transmission processor 30 via the USB plug 34. Noted that more than one RJ-45 plug is able to be added here for other use purposes.

In addition, the Internet apparatus 50 can be a network card placed in a computer, or a wired or wireless network box, and an expansion of the disclosure not shown in the Figures.

Furthermore, several conductive pillars 60 are disposed between the power converter 20 and the data transmission processor 30. The conductive pillars 60 not only electrically connect the power converter 20 and the data transmission processor 30, but also support the power converter 20 and the data transmission processor 30. Additionally, several high-frequency impedance components (such as ferrite beads) can be used to the power converter 20 in order to isolate noise generated between the conductive pillars. Also, this is thus favorable for an EMI (Electro-Magnetic Interference) qualify test.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What claimed is:

1. An Ethernet adapter, electrically connected between a power line and an Internet apparatus, comprising:
a power converter electrically connected to the power line for converting power of the power line to operating power;
a data transmission processor stacked with the power converter and electrically connected to the power converter and the power line for receiving the operating power and a data signal from the power line and transmitting the data signal to the Internet apparatus.

2. The Ethernet adapter as claimed in claim 1, wherein the power converter comprises a first plug electrically connected to the power line and at least one second plug electrically connected to the Internet apparatus.

3. The Ethernet adapter as claimed in claim 1, wherein the power converter comprises a first plug electrically connected to the power line and a plurality of second plugs electrically connected to a plurality of electronic devices to provide power to the electronic devices.

4. The Ethernet adapter as claimed in claim 1, wherein the operating power is DC power-converted from AC power of the power line by the power converter.

5. The Ethernet adapter as claimed in claim 1, wherein the data transmission processor comprises a transmission chip.

6. The Ethernet adapter as claimed in claim 5, wherein the transmission chip comprises a power line coupler, an analog signal driver, an analog signal converter and an access controller, wherein the power line coupler acquires and receives the data signal from the power line and transmits the data signal to the analog signal driver, the analog signal driver amplifies the data signal to an amplified data signal and transmits the amplified data signal to the analog signal converter, the analog signal converter converts the amplified data signal to a converted data signal, and the access controller accesses, shares, modulates and codes the converted data signal.

7. The Ethernet adapter as claimed in claim 6, wherein the data transmission processor comprises a RJ-45 plug for transmitting the data signal to the Internet apparatus.

8. The Ethernet adapter as claimed in claim 1, wherein the data transmission processor comprises a RJ-45 plug for transmitting the data signal to the Internet apparatus.

9. The Ethernet adapter as claimed in claim 1, wherein the data transmission processor comprises a USB plug electrically connected to the Internet apparatus for receiving the operating power from the Internet apparatus.

10. The Ethernet adapter as claimed in claim 1, further comprising at least one conductive pillar disposed between the power converter and the data transmission processor for supporting and electrically connecting the power converter and the data transmission processor.

11. The Ethernet adapter as claimed in claim 1, wherein the power converter comprises a plurality of high-frequency impedance components for noise isolation.

12. The Ethernet adapter as claimed in claim 11, wherein the high-frequency impedance components are ferrite beads.

13. The Ethernet adapter as claimed in claim 1, wherein the Internet apparatus is a network card.

14. The Ethernet adapter as claimed in claim 1, wherein the Internet apparatus is a wireless network box.

15. The Ethernet adapter as claimed in claim 1, wherein the Internet apparatus is a wired network box.
